(19) United States
(12) Patent Application Publication
(10) Pub. No.: US 2008/0026197 A1
(43) Pub. Date: Jan. 31, 2008

(54) Multi-layered gliding board comprising a polyethylene and ethylene vinyl acetate copolymer foam layer and an ethylene based octene plastomer film layer

(76) Inventor: Kwong Kee Cheung, Shatin (HK)

Correspondence Address: LAW OFFICES OF CLEMENT CHENG, 17220 NEWHOPE STREET #127, FOUNTAIN VALLEY, CA, 92708, US

(21) Appl. No.: 11/897,287

(22) Filed: Aug. 30, 2007

Related U.S. Application Data
(63) Continuation-in-part of application No. 11/103,554, filed on Apr. 12, 2005.

(51) Int. Cl. B32B 7/02; B32B 27/32; B32B 38/14

(52) U.S. Cl. 428/215; 156/281; 428/319.9

(57) ABSTRACT

The invention relates to multi-layered laminated foam gliders with improved bonding characteristics and surface smoothness which can be used as a bodyboard, a snow sled or other gliding boards. In general, the foam gliders are multi-layered structure of polymer foam and polymer film, comprising a polyethylene and ethylene vinyl acetate copolymer foam sheet, an intermediate polymer film layer of ethylene based octene plastomer and a polyolefin film layer. The polyolefin film layer may include a graphic image. The structure provide improved graphic image definition with a smooth texture on the graphic imprinted polyolefin film surface and the intermediate polymer film layer improve bond strength between polyolefin film layer and polyethylene and ethylene vinyl acetate copolymer foam sheet. A method of continuous fabrication is also disclosed.

This application is a divisional continuation in part of U.S. patent application Ser. No. 11/103,554 having the same inventor Kwong Kee Cheung and having the same title, filed Apr. 12, 2005.

### TECHNICAL FIELD

This invention relates to foam gliders for recreational use and, more particularly, to a laminated gliding board with improved bonding characteristics and surface smoothness. The gliding board can be used as a bodyboard, a snow sled, a grass gliding board, a sand gliding board or other gliding boards for recreational purpose.

### BACKGROUND OF THE INVENTION

A bodyboard or a snow sled made of polyethylene foam is typically composed of a number of polyethylene foam and polyethylene film layers that are laminated together by some conventional laminating processes. One conventional process is by heating the layers and the heated surfaces are immediately pressed and fused together by a pair of nip rollers. This laminating process is typically applied for bonding between a polyethylene foam layer to another polyethylene foam layer. Another conventional process of lamination typically applied for bonding between a polyethylene film layer and a polyethylene foam layer is to apply heat to the film layer with a heated nip roller on the film side and a normal nip roller on the foam side, where the heated nip roller generally contains an engraved pattern of convex and concave area for better heat transfer. The resulting polyethylene film/foam laminate is then often heat laminated onto a standard foam core.

Both of these laminating processes form a bonding between the two layers by localized collapse and fusion of foam cells on the surface of the respective layers. In order to acquire a good bonding between the two layers, the fusion temperature of polymeric material on the surface of the respective layers have to be within a very narrow temperature range. Otherwise inadequate bonding may result because the surface material on one layer has not heat up to the fusion state. If a higher heating temperature is applied to both surfaces of the layers, excessive melting of the surface material on the layer with lower fusion temperature may occur. Accordingly, there is need to provide a lamination method with improved bond strength to bond two polymer foam layers with difference fusion temperature caused by difference in polymeric material or density.

One limitation of the film lamination method using heated nip roller is that the process often uses micro-cellular high density foam sheets to improve adhesion between the film and foam layers. Because the standard foam core does not have a perfectly planar surface, bonding between the film and foam core is limited to the apexes of the cells on the surface of the foam core. Therefore the points of bonding are not uniform and inadequate across the bonding surfaces. The micro-cellular foam sheet contains smaller peaks and valleys and the separation between the peaks is closer. As a result, the surface area of contact between the film and foam sheet is increased. However the contact points are still localized to the apexes of the cells on the surface of the foam sheet. This kind of structure is still prone to delamination by mechanical contact forces, the effect of heat, and by the effect of water. Therefore it is desirable to provide a lamination method with improved bonding between film and foam layers.

In addition, the film lamination method generally cannot use a flat roller as the heated nip roller for laminating a polyethylene film to a polyethylene foam sheet because the heat transfer rate is too low to bring the foam layer underneath the film layer to the required fusion temperature. A higher temperature employed by the heated nip roller can cause undesirable shrinkage of the film layer. In the case of the heated nip roller having an engraved pattern of convex and concave area, heat transfer rate is higher at the contact area that protrude from the engraved roller. As a result, heat bond between the polyethylene film/foam layers occurs at those localized contact area.

A traditional gliding board made of polyethylene foam typically contains a printed image on the film layer which is generally laminated onto the top deck of the board for decoration purpose. Conventionally a polyethylene film with a printed image is generally laminated onto the board with a convex and concave pattern due to the limitation of the film lamination method using heated nip roller as described. Even though a high density polyethylene foam sheet is normally applied to bond with the polyethylene graphic film, the resulting graphic image having convex and concave pattern have inferior image definition compared with a graphic image having a smooth surface. It would be advantageous to provide a system for applying sharp, distinct and wear-resistant graphics to a polyethylene foam core with a smooth texture on the graphic film surface.

It is well-know that polymer foam sheet having a very small cell structure can improve the surface smoothness of polymer film bonded to the foam sheet. One common polymer foam with very small cell structure is polyethylene and ethylene vinyl acetate copolymer foam. However polyethylene and ethylene vinyl acetate copolymer has significant higher fusion temperature than polyethylene. As a result, a higher temperature is required and may cause undesirable shrinkage of the polyethylene film or foam layer if using conventional lamination method. Accordingly, there is a need for a thermally laminated foam board with improved bonding characteristics between a polyethylene and an ethylene vinyl acetate copolymer foam layer and a polyethylene foam or polyethylene film layer.

### SUMMARY OF THE INVENTION

The present invention provides a method to produce a polyethylene foam core glider with improved smoothness on the outer film surface. The present invention, briefly summarized, in one embodiment discloses an improved foam glider comprising an elongated expanded polyethylene foam core 23 having a core thickness and a top, bottom, side, front and back surfaces, a first polyolefin film 11 having an outer surface 10 and an inner surface 12, a polyethylene and ethylene vinyl acetate copolymer foam layer 17 having an outer 16 and inner surfaces 18, a first intermediate polymer film layer of ethylene based octene plastomer 14 bonded on its outer surface 13 to the inner surface 12 of the polyolefin film and bonded on its inner surface 15 to the outer surface 16 of the foam layer 17, a second intermediate polymer film layer of ethylene based octene plastomer 20 bonded on its outer surface 19 to the inner surface 18 of the foam layer 17 and bonded on its inner surface to top, side, front and back surfaces of the core 23, and a polyethylene film 26 bonded on its inner surface 25 to the bottom surface 24 of the core 23. The polyolefin film may comprise a polyethylene, a polypropylene polymer or a blend of polyethylene with about 1 to 10% ethylene vinyl acetate. The polyolefin film may include a graphic image printed on its inner surface. The first intermediate film layer may be thermally bonded to the polyolefin film and the foam layer. The second intermediate film layer may be thermally bonded to the core and the foam layer. The board may further comprise a graphically imprinted film layer 8 bonded to the outer surface 10 of the first film layer 11. The polyethylene film may comprise a low-density polyethylene, high-density polyethylene, a blend of polyethylene with about 1 to 10% ethylene vinyl acetate and a blend of high-density polyethylene with about 10 to 40% low-density polyethylene.

Accordingly, the general object of the present invention is to provide a system for bonding a polyolefin film to a polyethylene and ethylene vinyl acetate copolymer foam layer with improved bond strength.

Another object is to provide a system for applying sharp, distinct and wear-resistant graphics to a polyethylene foam core with a smooth texture on the graphic film surface.

Another object is to provide an improved foam foam glider in which different polyolefin materials may be laminated together with improved bonding.

Another object is to provide an improved foam foam glider in which allows the layers of different polyolefin material or different density to be laminated together at lower and less exact temperature ranges.

### BRIEF DESCRIPTION OF THE DRAWINGS

FIG. 1 is a front view of the gliding board.

FIG. 2a is a perspective and partial sectional view of the first embodiment of the gliding board.

FIG. 2b is a perspective and partial sectional view of the second embodiment of the gliding board.

FIG. 3a is a schematic diagram showing the process by which a film layer is bonded to a foam layer.

FIG. 3b is a schematic diagram showing the process by which a polyolefin film layer is laminated to a polyethylene and ethylene vinyl acetate copolymer foam layer with an intermediate polymer film layer of the preferred embodiments.

FIG. 4 is a schematic diagram showing the process by which a laminated skin is heat laminated to a polyethylene foam core.

FIG. 5 is an enlarged sectional view of intermediate polymer film layer between polyolefin film layer and polyethylene and ethylene vinyl acetate copolymer foam layer of the preferred embodiments.

FIG. 6 is a side cross-section of the lamination of an intermediate polymer film layer to a layer of ethylene vinyl acetate copolymer foam.

FIG. 7 is a side cross-section of the lamination of a polyethylene or polypropylene film layer to a layer of intermediate polymer film layer and a layer of ethylene vinyl acetate copolymer foam.

FIG. 8 is a side cross-section of a lamination of a first polyethylene or polypropylene film layer to a second polyethylene or polypropylene film layer and a layer of intermediate polymer film layer with a layer of ethylene vinyl acetate copolymer foam.

FIG. 9 is a side cross-section of a lamination of a layered structure having a first and second intermediate polymer film layer.

FIG. 10 is a side cross-section of a lamination of a layered structure having a first and second intermediate polymer film layer bonded to a lower polyethylene sheet.

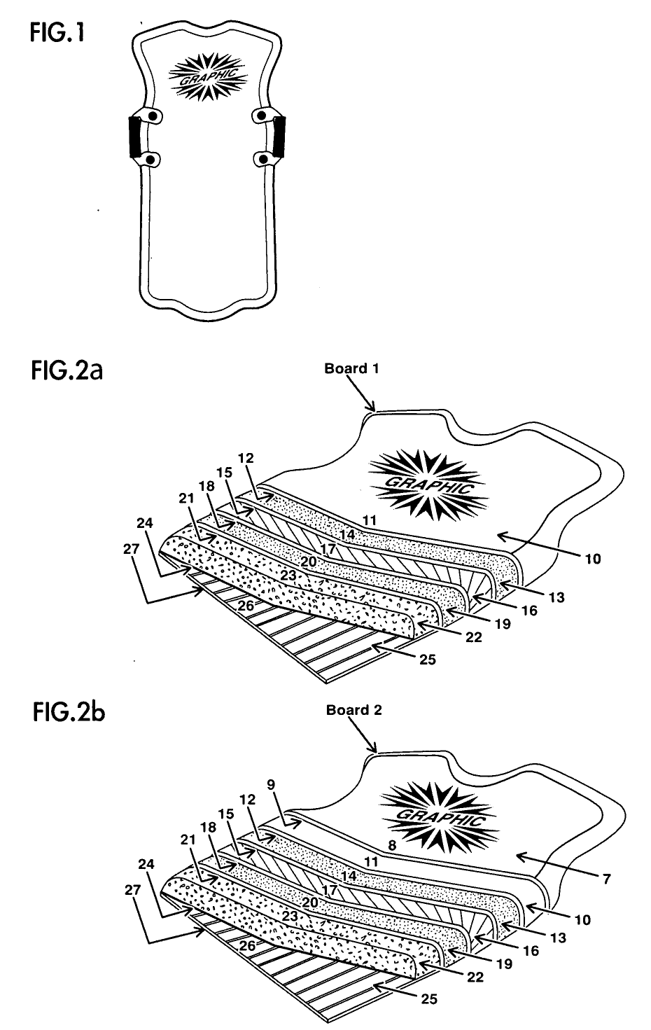

### DETAILED DESCRIPTION OF THE PREFERRED EMBODIMENTS

The following are elements of the first embodiment of the gliding board shown in FIG. 2a:

board 1,

first polyolefin film outer surface 10,

first polyolefin film 11,

first polyolefin film inner surface 12,

first intermediate polymer film layer of ethylene based octene plastomer outer surface 13,

first intermediate polymer film layer of ethylene based octene plastomer 14,

first intermediate polymer film layer of ethylene based octene plastomer inner surface 15,

polyethylene and ethylene vinyl acetate copolymer foam layer outer surface 16,

polyethylene and ethylene vinyl acetate copolymer foam layer 17,

polyethylene and ethylene vinyl acetate copolymer foam layer inner surface 18,

second intermediate polymer film layer of ethylene based octene plastomer outer surface 19,

second intermediate polymer film layer of ethylene based octene plastomer 20,

second intermediate polymer film layer of ethylene based octene plastomer inner surface 21,

foam core 23,

foam core bottom surface 24,

polyethylene film inner surface 25,

polyethylene film 26,

intermediate polymer bonding film layer 2828.

FIG. 2a illustrates the first embodiment of an improved foam glider which is generally indicated at Board 1. The foam glider is comprised of six layers laminated together. Top layer 11 is a graphically-imprinted polyolefin film. The graphic images are imprinted on the inner surface 12 of top layer 11 using any conventional process for printing on polyethylene or polypropylene, such as the corona printing process, in which an electrical discharge temporarily alters the surface structure of the film, allowing inks to adhere to the film. The polyolefin film is nonopaque and the graphic image is viewable from outside of the top film. The top film layer 11 has a thickness of between 0.02 mm and 0.15 mm. First intermediate polymer film layer 14 is an ethylene based octene plastomer.

First intermediate polymer film layer 14 has a thickness of between 0.02 mm and 0.12 mm. First intermediate polymer film layer 14 has a density in the range of 0.84 to 0.94 g/cm³, and preferably a density of 0.88 g/cm³. The EXACT™ octene plastomer provided by the EXXONMOBIL corporation, may be employed in the preferred embodiment. Generally, octene plastomers has a relatively low melting point of approximately around 73 C (or 164 F) which is less than the melting point range of the other plastic layers in the gliding board.

Polyethylene and ethylene vinyl acetate copolymer foam layer 17 is closed-cell foam made of a polymer blend of polyethylene and ethylene vinyl acetate copolymer. Foamed polymer blends are made by compounding different types of polymers and copolymers and then foaming them. Copolymer foam layer 17 has a thickness of between 1 mm and 5 mm, and preferably a thickness of 3 mm. Copolymer foam layer 17 has a density in the range of 4 to 8 lb/ft³, and preferably a density of 6 lb/ft³. Second intermediate polymer film layer 20 is of the same structure and composition as first intermediate polymer film layer 14.

Foam core 23 is a layer of closed-cell polyethylene foam, and acts as the core of Board 1. Foam core 23 has a thickness of between 0.2 inch and 2.5 inch and preferably a thickness of 1 inch. Foam core 23 has a density in the range of 1.6 to 4 lb/ft³, and preferably a density of 2.2 lb/ft³. It is contemplated that core 23 may be formed from two or more layers laminated together. Polyethylene film 26 is a polyethylene film layer laminated to the other layers. Polyethylene film layer 26 has a thickness of between 0.2 and 1.5 mm, and preferably a thickness of 0.5 mm.

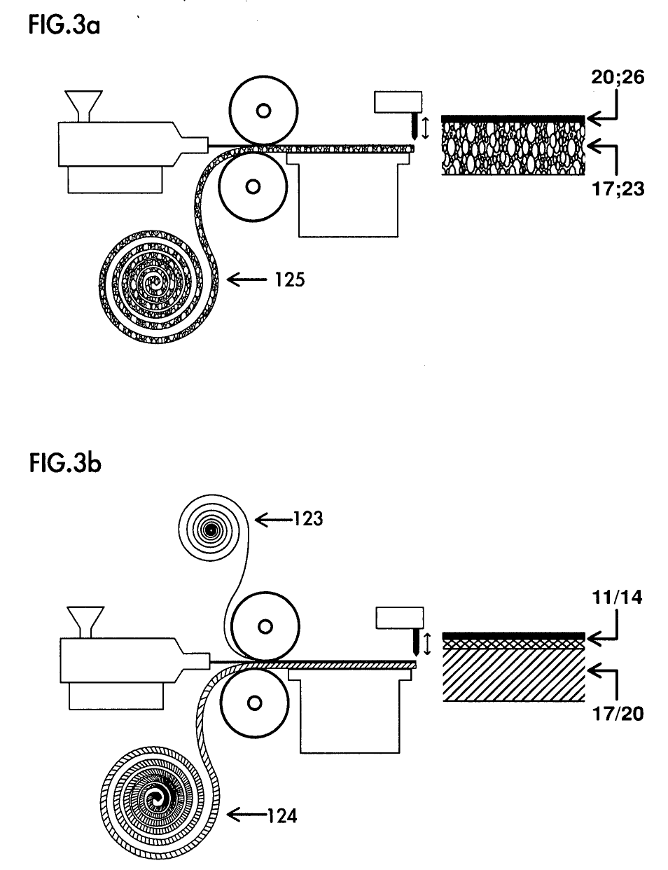

As shown in FIG. 3b, the ethylene based octene plastomer 14 in this embodiment, as well as the following embodiments, fills in the gaps between the peaks and valleys, concaves, or inherent surface roughness of each of the opposed surfaces of the two adjacent layers namely the first polyolefin film layer 11 and the copolymer foam layer 17 to have intimate contact and better bonding. The ethylene based octene plastomer 14 is an adhesive resin that melts generally in the range of around 165° Fahrenheit or any temperature generally lower than the polyethylene and ethylene vinyl acetate copolymer foam layer 17 so there is no high temperature heat lamination required. Different brands of octene plastomer 14 will melt at different ranges.

Board 1 is formed in a series of steps. First, the first polyolefin film layer 11 is imprinted with the desired graphics using a conventional imprinting procedure. With reference to FIG. 3a, the polyethylene and ethylene vinyl acetate copolymer foam layer 17 is made by compounding ethylene vinyl acetate with polyethylene so that a majority of the material is polyethylene. The polyethylene and ethylene vinyl acetate copolymer foam layer 17 is called the ethylene vinyl acetate copolymer foam layer 17 or the copolymer foam layer 17 for short. The ethylene vinyl acetate copolymer foam layer 17 has a vinyl acetate content of preferably 1-10 percent by weight of the total weight of copolymer. Copolymer foam layer 17 is unrolled from a bottom roll 125 and hot plastomer 20 is extruded and with pressure is applied to surface 21 of the second intermediate polymer film layer 20 to form a laminate layer 17/20 where the foam layer 17 is bonded to the second intermediate polymer film layer. The plastomer film 20 is heat laminated to polyethylene and ethylene vinyl acetate copolymer foam layer 17 at a temperature generally in the range 198° to 260° Fahrenheit.

As shown in FIG. 3b, laminate layer 17/20 is then fed from a bottom roll 124 and the first polyolefin film layer 11 is fed from top roll 123. As laminate layer 17/20 and the first polyolefin film layer 11 are fed from bottom and top rolls 124 and 123, respectively, the first intermediate polymer film layer 14 is extruded, using a conventional extrusion process, between the first polyolefin film inner surface 12 of the first polyolefin film layer 11 and the copolymer foam layer outer surface 16 of the copolymer foam layer 17 to form a top laminate of layers 11, 14, 17 and 20. The plastomer film layer 14 is heat laminated to polyethylene and ethylene vinyl acetate copolymer foam layer 17 and polyolefin film layer 11 at a temperature generally in the range 198° to 330° Fahrenheit. This laminated sheet is then cut and configured to the desired shape and size.

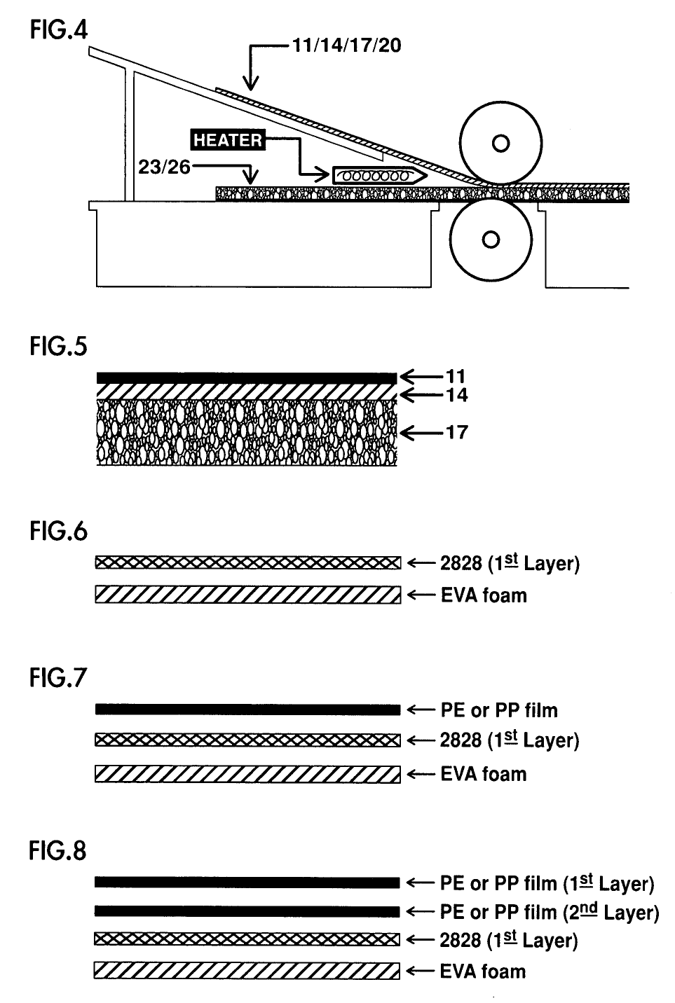

As shown in FIG. 3a, core 23 is fed from a bottom roll 125 and hot polyethylene film layer 26 is extruded and with pressure is applied to the surface of core 26 to form a laminated layer 23/26. Laminated layer 23/26 is then shaped to form the desired front, tail and side rails configurations. As shown in FIG. 4, the top laminate of layers 11/14/17/20 are then heat laminated to the top surface of the core 23 of the laminated layer 23/26. The outer portions of the top laminate are then wrapped over and heat laminated to the side edges of front, tail and side rails. Excess is then trimmed as necessary, completing the covering of the side surfaces of Board 1.

Also, the top layers can also be applied on the bottom with a clear or transparent polyethylene film 26 outside protection layer. One can apply the top layers to the bottom by applying the top layers to the foam core, then flipping the board upside down and then applying the same layers to the bottom surface of the foam core. The layers on the bottom would now be namely: a transparent polyethylene film 26, the graphically imprinted first polyolefin film 11, first intermediate polymer film layer of ethylene based octene plastomer 14, polyethylene and ethylene vinyl acetate copolymer foam layer 17 and second intermediate polymer film layer of ethylene based octene plastomer 20. However, the names of the top layers being applied to the bottom of the foam core would change, even though the physical construction does not change except for the addition of the transparent polyethylene film layer 26 which could be added to the top or bottom. Actually, multiple layers of transparent polyethylene film 26 could be added to the top or bottom surface for additional protection.

In any case, the names of the top layers are now called bottom layers. Therefore, the top first polyolefin film 11 becomes the bottom first polyolefin film 11, the top first intermediate polymer film layer of ethylene based octene plastomer 14 becomes the bottom first intermediate polymer film layer of ethylene based octene plastomer 14, the top polyethylene and ethylene vinyl acetate copolymer foam layer 17 becomes the bottom polyethylene and ethylene vinyl acetate copolymer foam layer 17, the top second intermediate polymer film layer of ethylene based octene plastomer 20 becomes the bottom second intermediate polymer film layer of ethylene based octene plastomer 20, and finally one or more layers of a transparent polyethylene film 26 can be wrapped around the whole entire board, just at the bottom or just the top depending upon usage of the board and the amount of abrasion protection necessary.

The following are elements of the second embodiment of the gliding board shown in FIG. 2b:

board 2,

outer polyolefin film layer outer surface 7,

outer polyolefin film layer 8,

outer polyolefin film layer inner surface 9,

inner polyolefin film outer surface 10,

inner polyolefin film 11,

inner polyolefin film inner surface 12,

first intermediate polymer film layer of ethylene based octene plastomer outer surface 13,

first intermediate polymer film layer of ethylene based octene plastomer 14,

first intermediate polymer film layer of ethylene based octene plastomer inner surface 15,

polyethylene and ethylene vinyl acetate copolymer foam layer outer surface 16,

polyethylene and ethylene vinyl acetate copolymer foam layer 17,

polyethylene and ethylene vinyl acetate copolymer foam layer inner surface 18,

second intermediate polymer film layer of ethylene based octene plastomer outer surface 19,

second intermediate polymer film layer of ethylene based octene plastomer 20,

second intermediate polymer film layer of ethylene based octene plastomer inner surface 21,

foam core 23,

foam core bottom surface 24,

polyethylene film inner surface 25,

polyethylene film 26,

intermediate polymer bonding film layer 2828.

FIG. 2b shows a second embodiment Board 2. In this embodiment, Board 2 has seven layers rather than six. The construction of the second embodiment is the same as the first embodiment, except the top most layer. In this second embodiment, the top graphic film comprises an outer polyolefin film layer 8 having an outer surface 7 and inner surface 9, and having a graphic image printed on the inner surface 9; and an inner polyolefin film layer 11 having an outer surface 10 and inner surface 12. The outer polyolefin film is nonopaque and the graphic image is viewable from outside of the top film. The outer graphically imprinted polyolefin film layer 8 has a thickness of between 0.02 mm and 0.15 mm. The inner polyolefin film layer 11 has a thickness of between 0.01 mm and 0.15 mm.

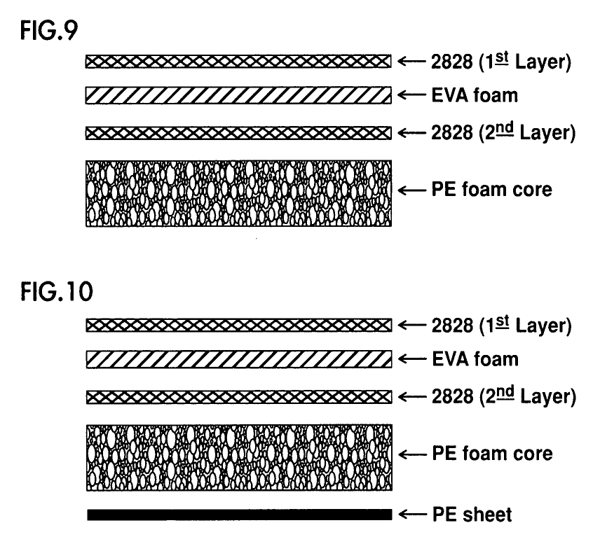

FIGS. 4 through 10 show the various laminations that can be used for laminating various layers to make laminated layers that are then bonded together to form the gliding board. Also, the top layers can also be applied on the bottom with a clear or transparent polyethylene film 26 outside protection layer. One can apply the top layers to the bottom by applying the top layers to the foam core, then flipping the board upside down and then applying the same layers to the bottom surface of the foam core, namely the layers of: a transparent polyethylene film 26, top graphically imprinted outer film layer 8 which is now the bottom graphically imprinted outer film layer, inner polyolefin film 11, first intermediate polymer film layer of ethylene based octene plastomer 14, polyethylene and ethylene vinyl acetate copolymer foam layer 17 and the second intermediate polymer film layer of ethylene based octene plastomer 20. When the top layers are placed on the bottom, the layers are now called bottom layers so that the top graphically imprinted outer film layer 8 is now called the bottom graphically imprinted outer film layer 8, the top inner polyolefin film 11 is now called the bottom inner polyolefin film 11, the top first intermediate polymer film layer of ethylene based octene plastomer 14 is now called the bottom first intermediate polymer film layer of ethylene based octene plastomer 14, the top polyethylene and ethylene vinyl acetate copolymer foam layer 17 is now called the bottom polyethylene and ethylene vinyl acetate copolymer foam layer 17, the top second intermediate polymer film layer of ethylene based octene plastomer 20, is now called the bottom second intermediate polymer film layer of ethylene based octene plastomer 20 and finally one or more layers of the transparent polyethylene film 26 can be applied as necessary to the exterior for protection as in the first embodiment.

Gliding boards thus have two faces so that they can be flipped upside down. When a gliding board is flipped upside down, the top face becomes the bottom face and the bottom face becomes the top face. If the gliding board is flipped upside down again for a second time, the bottom layers which were previously the top layers are now again on the top and so therefore are now top layers. One can flip a gliding board upside down many times. Each time a gliding board is flipped upside down, the top layers becomes the bottom layers and the bottom layers become the top layers. The top and bottom orientation is relative to the core. When layers are above the core, they are the top layers, and when layers are below the core they are the bottom layers.

The foregoing describes the preferred embodiments of the invention. Modifications may be made without departing from the spirit and scope of the invention as set forth in the following claims. The present invention is not limited to the embodiments described above, but encompasses any and all embodiments within the scope of the following claims. For example, the sports board glider can be made in a variety of shapes. Also, extra transparent layers may be added for additional protection. Also, layers can be made with increased thickness to be more wear resistant.

1. A multi-layered foam composite glider, comprising:
a polyethylene film layer having an outer surface and inner surface, a graphic imaged being imprinted on the inner surface of said polyethylene film;
a foam sheet made of a blend of polyethylene and ethylene vinyl acetate, said foam sheet has a density greater than the density of said polyethylene foam core and has a thickness ranges from 1 mm to 5 mm;
a first bonding layer disposed between and bonding said polyethylene film and said foam sheet together, said bonding layer comprising ethylene based octene plastomer;
a polyethylene foam core having a top, bottom, side, front and back surfaces;
a second bonding layer disposed between and bonding said foam core and said foam sheet together, said bonding layer comprising ethylene based octene plastomer; and
said polyethylene film layer, said first bonding layer, said foam sheet layer, said second bonding layer and said polyethylene foam core forming at least five layers of a laminated recreational gliding board; and
wherein said foam sheet has a fusion temperature higher than that of polyethylene film and polyethylene foam core.

2. The composite glider of claim 1, wherein said first and second bonding layers have a thickness ranging from about 0.02 to about 0.12 mm, and
said bonding layers are applied to the bonding surface by extrusion.

3. The composite glider of claim 1, wherein
the polyethylene film layer has a thickness ranging from about 0.02 to about 0.15 mm;
the polyethylene foam core has a thickness ranging from about 0.2 to about 2.5 inches.

4. The composite glider of claim 1, wherein said polyethylene film layer further comprises:
an outer nonopaque film layer having an outer surface and inner surface, and having a graphic image printed on said inner surface of said second outer film layer; and
an inner film layer having an outer surface and inner surface, and
said outer surface of said inner film bonded with said inner surface of said outer film, said inner surface of said inner film bonded with said first bonding layer.

5. The composite glider of claim 1 further comprising:
a second polyethylene film layer having an inner surface and an outer surface;
said inner surface of said second polyethylene film layer bonded to said bottom surface of said polyethylene foam core.

6. The method of making a multi-layered foam composite glider, comprising the steps of:
shaping a polyethylene foam core;
shaping a foam sheet made of a blend of polyethylene and ethylene vinyl acetate, said foam sheet has a density greater than the density of said polyethylene foam core and has a thickness ranges from 1 mm to 5 mm,
providing a polyethylene film layer having an outer surface and inner surface;
printing a graphic image on the inner surface of said polyethylene film;
applying a first bonding layer disposed between and bonding said polyethylene film and said foam sheet together, said bonding layer comprising ethylene based octene plastomer; and
applying a second bonding layer between said foam core and said foam sheet together, said bonding layer comprising ethylene based octene plastomer; wherein
said foam sheet has a fusion temperature higher than that of polyethylene foam core and polyethylene film, and;
said polyethylene film layer, said first bonding layer, said foam sheet layer, said second bonding layer and said polyethylene foam core forming at least five layers of a laminated recreational gliding board.

7. The method of claim 6, wherein the step of printing the graphic image on the inner surface of said polyethylene film further comprises the substep of selecting a graphic imprinted polyethylene film that is made of:
an outer nonopaque polyethylene film layer having a thickness generally in the range of about 0.02 to about 0.15 mm, and having a graphic image printed on its inner surface; and
an inner polyethylene film layer having a thickness generally in the range of about 0.01 to about 0.15 mm; wherein the outer film bonded with the inner film, wherein the inner film is bonded with the first bonding layer.

8. The method of claim 6, wherein the step of shaping a foam sheet further includes the limitation wherein the foam sheet has an average foam density of between about 3 and 8 lb/ft³.

9. The method of claim 6, wherein the step of shaping a foam core further includes the limitation wherein the foam core has an average foam density of between about 1.6 and 4 lb/ft³.

10. The method of claim 9, wherein the step of applying the first bonding layer further includes the limitation wherein ethylene based octene plastomer is heat laminated to the foam sheet and the polyethylene film layer at a temperature generally in the range 198° F. to 330° F.

11. A multi-layered foam composite glider, comprising:
a polyethylene film layer having an outer surface and inner surface, a graphic imaged being imprinted on the inner surface of said polyethylene film;
a foam sheet made of a blend of polyethylene and ethylene vinyl acetate, said foam sheet has a density greater than the density of said polyethylene foam core and has a thickness ranges from 1 mm to 5 mm;
a first bonding layer disposed between and bonding said polyethylene film and said foam sheet together, said bonding layer comprising ethylene based octene plastomer;
a polyethylene foam core having a top, bottom, side, front and back surfaces;
a second bonding layer disposed between and bonding said foam core and said foam sheet together, said bonding layer comprising ethylene based octene plastomer; and
said polyethylene film layer, said first bonding layer, said foam sheet layer, said second bonding layer and said polyethylene foam core forming at least five layers of a laminated recreational gliding board; and
wherein said first and second bonding layers have a melting temperature lower than that of polyethylene foam core, polyethylene film layer and foam sheet.

12. The composite glider of claim 11, wherein said first and second bonding layers have a thickness ranging from about 0.02 to about 0.12 mm, and
said bonding layers are applied to the bonding surface by extrusion.

13. The composite glider of claim 11, wherein the polyethylene film layer has a thickness ranging from about 0.02 to about 0.15 mm;
the polyethylene foam core has a thickness ranging from about 0.2 to about 2.5 inches.

14. The composite glider of claim 11, wherein said polyethylene film layer further comprises:
an outer nonopaque film layer having an outer surface and inner surface, and having a graphic image printed on said inner surface of said second outer film layer; and
an inner film layer having an outer surface and inner surface, and
said outer surface of said inner film bonded with said inner surface of said outer film, said inner surface of said inner film bonded with said first bonding layer.

15. The composite glider of claim 11, wherein said foam sheet has an average foam density of between about 3 and 8 lb/ft³.

16. The composite glider of claim 11, wherein said foam core has an average foam density of between about 1.6 and 4 lb/ft³.

17. The composite glider of claim 11 further comprising:
a second polyethylene film layer having an inner surface and an outer surface;
said inner surface of said second polyethylene film layer bonded to said bottom surface of said polyethylene foam core.
